(19) United States
(12) Patent Application Publication
(10) Pub. No.: US 2026/0151306 A1
(43) Pub. Date: Jun. 4, 2026

(54) MEDICATION MANAGEMENT SYSTEMS AND RELATED METHODS

(71) Applicant: CAREHOME HEALTH SOLUTIONS, Wilmington, NC (US)

(72) Inventor: Aaron Trelease, Wilmington, NC (US)

(21) Appl. No.: 19/407,888

(22) Filed: Dec. 3, 2025

Related U.S. Application Data
(60) Provisional application No. 63/727,388, filed on Dec. 3, 2024.

(51) Int. Cl. A61J 7/00; A61J 7/04

(52) U.S. Cl. CPC A61J 7/0076; A61J 7/0418; A61J 7/0427; A61J 7/0481; A61J 2200/74

(57) ABSTRACT

A medication management and dispensing system is provided. The system includes a housing; a medication dispensing mechanism disposed within the housing, the medication dispensing mechanism including a plurality of compartments therein, each of the plurality of compartments configured to hold a predetermined dose of medication; a motor in the housing and operably coupled to the medication dispensing mechanism that is configured to engage the medication dispensing mechanism at a predetermined time and cause the medication dispensing mechanism to release the dose of medication; a receptacle disposed in the housing that receives the dispensed medication released by the medication dispensing mechanism; and a weight sensor operably associated with the receptacle that detects a weight of the dose of medication when the dose of medication is released into the receptacle causing a user to be alerted of presence of the dose of medication in the receptacle.

### CLAIM OF PRIORITY

This application claims the benefit of and priority to U.S. Provisional Application No. 63/727,388, filed Dec. 3, 2024, the content of which is hereby incorporated herein by reference in its entirety.

### FIELD

The present inventive concept generally relates to medical devices and, more particularly to, a medication management system.

### BACKGROUND

As the population ages, there are an increasing number of devices and systems that have been created to assist with medication management. Traditionally, medication management is accomplished using, for example, pill caddies or containers that are divided up into compartments that correspond to certain days of the week and/or times of the day. These containers do little more than aid in organizing medication.

Conventional systems exist that dispense medication; however, these devices generally require a wireless fidelity (WiFi) connection just to set up the device and an application installed on a phone to use the device. Furthermore, these devices usually require a user to physically push a button in order to dispense medication and may require input from outside medical providers remotely.

Other conventional devices, for example, the device disclosed in U.S. Pat. No. 11,602,488, require the patient to wear a device that includes motion, audio or even video sensors that determine if a patient took their medication. This system is considerably more complicated than other solutions as it requires a wearable device with sensors and communication with a medical provider that is “off-site” in order to monitor medication compliance.

U.S. Publication Number 2017/0020785 discusses a device that uses a robotic arm to open pill bottles and dispense the medication, but requires manual input from a patient or a caregiver. Thus, there is a desire for improved medication management systems.

### SUMMARY

Some embodiments of the present inventive concept provide a medication management and dispensing system. The system includes a housing; a medication dispensing mechanism disposed within the housing, the medication dispensing mechanism including a plurality of compartments therein, each of the plurality of compartments configured to hold a predetermined dose of medication; a motor in the housing and operably coupled to the medication dispensing mechanism that is configured to engage the medication dispensing mechanism at a predetermined time and cause the medication dispensing mechanism to release the dose of medication; a receptacle disposed in the housing that receives the dispensed medication released by the medication dispensing mechanism; and a weight sensor operably associated with the receptacle that detects a weight of the dose of medication when the dose of medication is released into the receptacle causing a user to be alerted of presence of the dose of medication in the receptacle.

In further embodiments, the system may include a timer associated with the system. The motor may operate responsive to the timer.

In still further embodiments, the medication dispensing mechanism may be a paddle wheel having compartments therein.

In some embodiments, the system may include a processor in communication with the motor and weight sensor that controls rotation of the paddle wheel according to a predetermined medication schedule; and generates an alert when the weight sensor indicates the dose of medication is in the receptacle.

In further embodiments of the present inventive concept, the weight sensor may detect whether a container placed on the receptacle contains consumed or unconsumed medication based on weight change patterns.

In still further embodiments of the present inventive concept the processor may disable further medication dispensing until a previous dose has been removed, acknowledged, or cleared by a caregiver.

In some embodiments, the alert may be one or more of an audible alert, a tactile alert and a visual alert.

In further embodiments, the processor may further generate an alert when the dose of medication has not been removed from the receptacle within a predetermined time and when an actual weight of the dose of medication is less than an expected weight of the dose of the medication.

In still further embodiments, the processor may determine whether a container has been returned to the receptacle before dispensing additional medication.

In some embodiments, the paddle wheel may be removable for external filling or replacement with pre-filled compartments.

In further embodiments, the housing may include a locking mechanism to restrict access to medication once the medication is loaded into the system.

In still further embodiments, the system may further include a display on the housing. The display may communicates alerts, dosage information, timer information, and/or compliance feedback.

In some embodiments, the system may further include a reservoir in the housing. The reservoir dispenses liquid into the receptacle. In certain embodiments, the liquid may be one of liquid medication and liquid for aiding a patient in swallowing the dose of medication.

In further embodiments, the plurality of compartments may correspond to days of a week and/or scheduled medication times.

In still further embodiments, the system may further include a communication interface configured to transmit compliance data to an external device.

Some embodiments of the present inventive concept provide methods for dispensing medication. The method includes loading a plurality of medication doses into respective compartments of a paddle wheel; rotating the paddle wheel via a motor to position a medication-filled compartment over a receptacle at a scheduled dispensing time; dispensing the medication into the receptacle; detecting, using a weight sensor, an amount of dispensed medication in the receptacle; comparing the detected amount with an expected medication dose; and generating an alert when the detected amount differs from the expected amount or the medication remains on the receptacle beyond a predetermined time.

### BRIEF DESCRIPTION OF THE DRAWINGS

FIG. 1 is a diagram illustrating perspective view illustrating systems for dispensing medications in accordance with some embodiments of the present inventive concept.

FIG. 2 is a diagram illustrating a container positioned on the receptacle to catch the medication dispensed in accordance with some embodiments of the present inventive concept.

FIG. 3 is a diagram illustrating a container positioned on the receptacle to catch water dispensed from the receptacle in accordance with some embodiments of the present inventive concept.

FIG. 4 is diagram illustrating an exploded view of systems illustrated in FIG. 1 in accordance with some embodiments of the present inventive concept.

FIG. 5 is diagram illustrating a top view of systems for dispending medications in accordance with some embodiments of the present inventive concept.

FIG. 6 is diagram illustrating a translucent view of the system showing an interior thereof in accordance with some embodiments of the present inventive concept.

FIGS. 7 and 8 are a diagram illustrating various views of a motor and paddle wheel in accordance with some embodiments of the present inventive concept.

FIGS. 9A through 9C are diagrams illustrating the various compartments of the wheel and the medication therein in accordance with some embodiments of the present inventive concept.

FIG. 10 is a high-level block diagram of a data processing system for use with a number intelligence module in accordance with some embodiments of the present inventive concept.

FIG. 11 is a diagram illustrating a system and a related mobile application (app) that communicates with the system in accordance with some embodiments of the present inventive concept.

FIG. 12A through 12G are various example screens of the mobile app in FIG. 11 that provide information about the system in accordance with some embodiments of the present inventive concept.

FIGS. 13A through 13C are example screenshots illustrating an example dashboard in accordance with some embodiments of the preset inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

As discussed in the background, as the population ages, there are an increasing number of devices and systems that have been created to assist with medication management. Traditionally, medication management is accomplished using, for example, pill caddies or containers that are divided up into compartments that correspond to certain days of the week and/or times of the day. These containers do little more than aid in organizing medication. In particular, they do little if anything to remind a patient to take their medication and do not assist them in maintaining a particular schedule. These containers also do not provide monitoring of compliance or assistance in loading or unloading the medication.

As further discussed above, some conventional systems exist that dispense medication, but may require Wifi, which may be largely useless if the power goes out. Other conventional devices have similar shortcomings. Accordingly, some embodiments of the present inventive concept provide systems and methods for dispensing multiple types of medication for a patient with the least amount of interaction with the patient or a caregiver as will be discussed further herein.

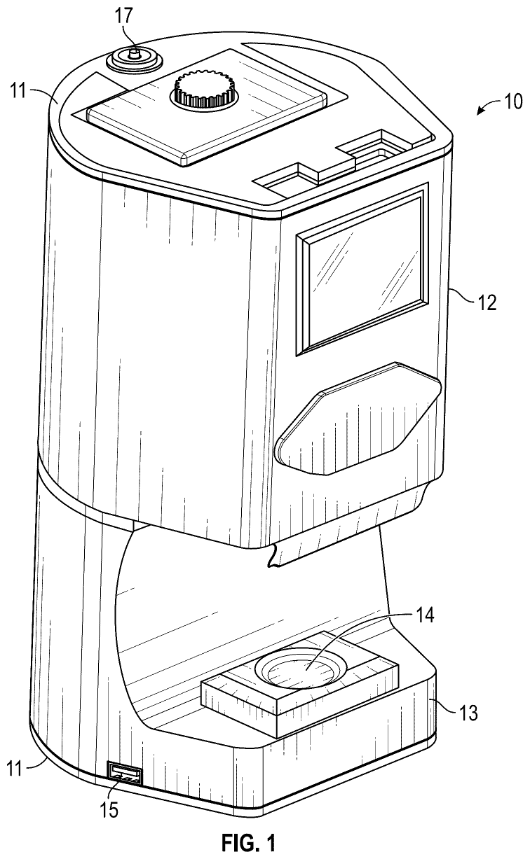

Referring first to FIG. 1, a diagram illustrating a system for dispensing medication in accordance with some embodiments of the present inventive concept will be discussed. As illustrated in FIG. 1, the electronic medication management system 10 incudes a housing 11 that encloses an upper compartment 12 and a lower compartment 13. It will be understood that there may be only one compartment or more than two compartments without departing from the scope of the present inventive concept. The upper compartment 12 may include moving parts of the system 10 as well as a reservoir as will be discussed further below. As illustrated, the upper compartment contains a locking mechanism 17 thereon. The locking mechanism 17 allows medication within the medication management system 10 to be secured so that a patient cannot access the medication. Although the locking mechanism is shows as having a key lock, embodiments of the present inventive concept are not limited thereto. Any locking mechanism may be used without departing from the scope of the present inventive concept may be used without departing from the scope of the present inventive concept. For example, a biometric lock that receives a thumb print or a digital combination lock may be used.

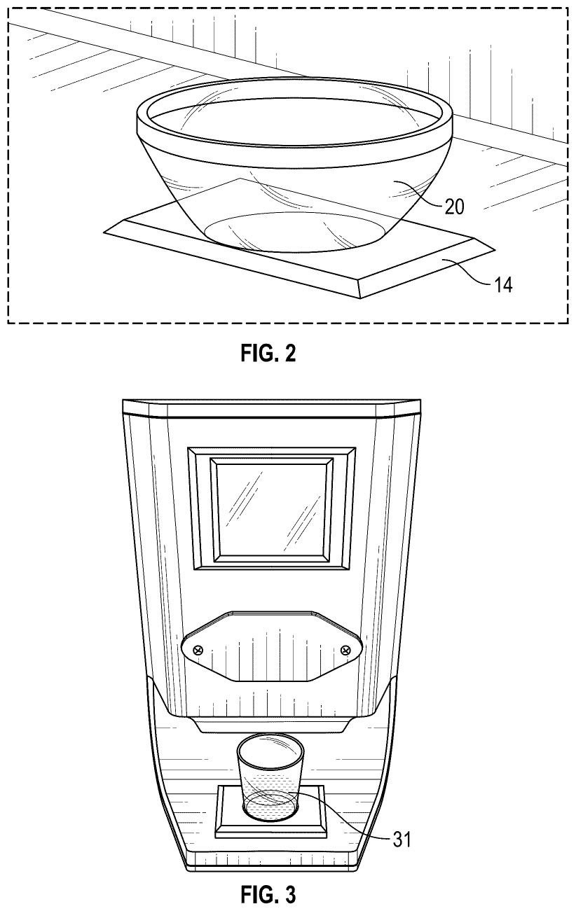

The lower compartment 13 may include a receptacle 14, a weight sensor 15, and a port 15, for example, a universal serial bus (USB) port. The receptacle is configured to receive a container that is configured to catch, for example, the medication when it is dispenses or water dispensed from the reservoir for facilitating swallowing the medication dispensed. An example container 20 positioned on the receptacle 14 for receiving/catching dispensed medication is illustrated in FIG. 2. An example container 31 for catching dispensed water is illustrated in FIG. 3. It will be understood that the embodiments of the system illustrated in FIGS. 1-3 are provided as an example only and, therefore, embodiments are not limited thereto. The system 10 could have a different components (less or more), different compartments and the like without departing from the scope of the present inventive concept. Furthermore, the containers 20 and 31 can be made of various materials and have different shapes and sizes without departing from the scope of the present inventive concept.

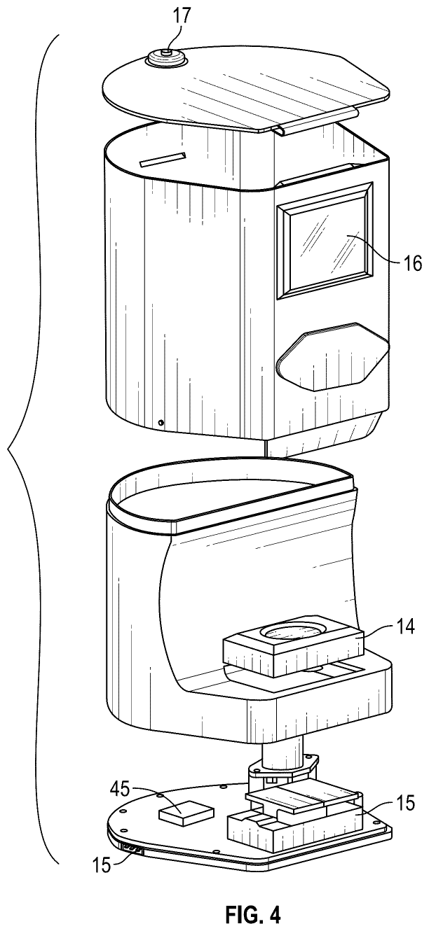

Referring now to FIG. 4, a diagram illustrated an exploded view of the system 10 illustrated in FIG. 1 will be discussed. As illustrated in FIG. 2, embodiments illustrated therein include a screen 16 for displaying information. The screen 16 may be operably connected to a circuit board 45 within the lower compartment 13 that communicates with an internal or external data processing unit (FIG. 10) such that the processor can use the screen 16 to display information relevant to system functionality. An external processor may be connected to the system 10 using the port 15 or wirelessly using WiFi, Bluetooth, NFC or the like. The receptacle 14 of FIG. 4 is configured to hold a container, for example, a small cup (FIGS. 2-3). As discussed, the container 20 catches the medication or fluid (31) as it exits the system 10. The receptacle 14 is operably connected to a weight sensor 15.

The weight sensor 15 can facilitate many functionalities of the system 10. For example, when medication is dispensed, the weight of the medication is sensed by the weight sensor 15. Once the medication is sensed, an alert may be sounded by the system. The alert could be audible, visual, tactile (vibration) or any combination of the three. This alert lets the patient or caregiver know that it is time for the patient to take the medication and the medication is dispensed in the exact amount the patient needs at that time.

In some embodiments, the system 10 knows the exact weight of the medication that should be dispensed at a particular time. Thus, if the weight of the medication dispensed does not match the expected weight, the system may indicate an error that should be investigated by the patient or caregiver. The actual weight may not match the expected weight for many reasons. For example, a pill may not get dispensed correctly, a user may not have loaded the medication correctly, the manufacturer of the medication may have changed the form of the medication, i.e. from a pill to a capsule, and the like. The comparison of the expected weight and actual weight of the dispensed medication may be performed by the internal or external processor without departing from the scope of the present inventive concept.

In some embodiments, the weight sensor 15 can be used to determine how long the medication is allowed to sit in the receptacle after it is dispensed. For example, if the medication is dispensed at 6 PM and the weight sensor 15 does not sense the medication being removed until 7 PM, the caretaker will know the patient did not take the medication on time. As it is understood, with certain medications it is very important that the patient take the medications at the proper time and at proper intervals to avoid overdose or other medication complications. Thus, this aspect of the present inventive concept allows the system to make sure that the patient is safely consuming their medications.

In some embodiments, the system 10 records all events associated with the system, for example, when the medication is dispensed, how long the medication sat in the receptacle 14 before it was removed, any discrepancy between the expected medication and the dispensed medication and the like. This information may be stored on the system 10 or communicated to an external data processing system without departing from the scope of the present inventive concept.

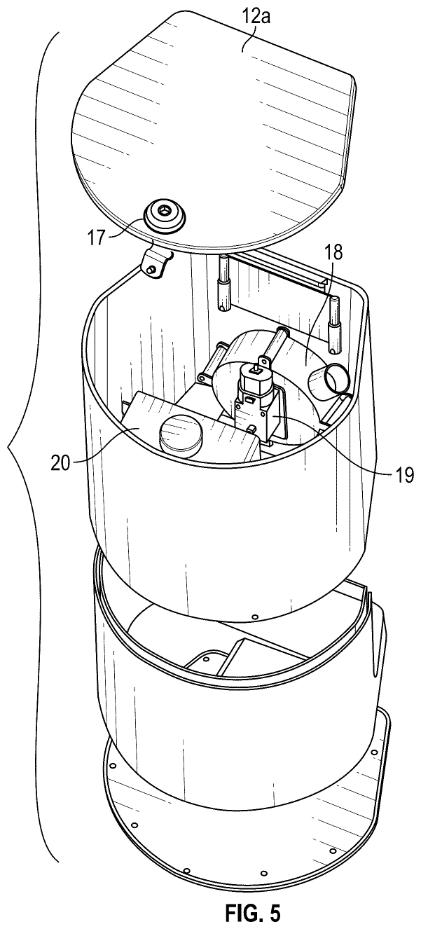

Referring now to FIG. 5, a diagram illustrating a top view of the system 10 will be discussed. As illustrated, a lid 12a of the system 10 is removed, which reveals an interior portion of the system 10. In embodiments illustrated in FIG. 5, the lid 12a of the upper compartment includes the locking mechanism 17 that secures the lid 12a of the upper compartment 12 to deter unwanted access to the medication therein. As further illustrated, the upper compartment 12 further includes a medication dispensing mechanism, for example, a paddle wheel 18, that is operably connected to a motor 19. In some embodiments, the motor 19 may be controlled by a microprocessor present in a data processing system. Also present in the upper portion 12 of the system 10 is a reservoir 20, which may be used store, for example, liquids for use in taking medication that is dispensed by the system or may be used for liquid medications. For example, once the dispensed medication is removed from the receptacle 14, this may cause the reservoir to dispense a liquid, for example, water to facilitate consuming the medication. In further embodiments, the medicine itself is liquid and may be dispensed. This aspect of the present inventive concept is illustrated in FIG. 3.

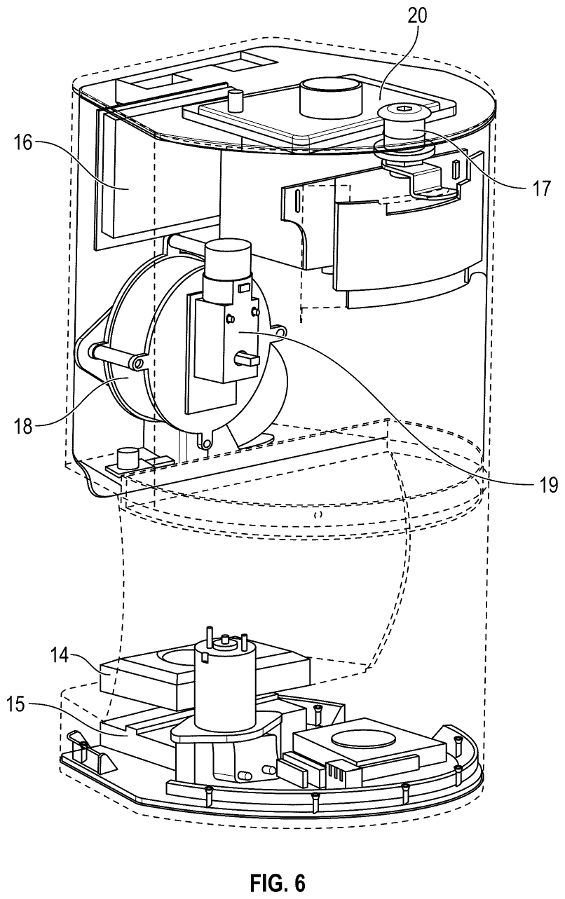

Referring now to FIG. 6, a diagram illustrating a translucent system 10 allowing an interior thereof to be seen will be discussed. As illustrated, the display or screen 16 is provided on a surface of the upper compartment 12. The reservoir 20, the paddle wheel 18 and the motor are shown in the upper compartment 12. The lower compartment 13 is shown as including the receptacle 14 and the weight sensor 15 as well as electronics and other mechanical aspects of the system.

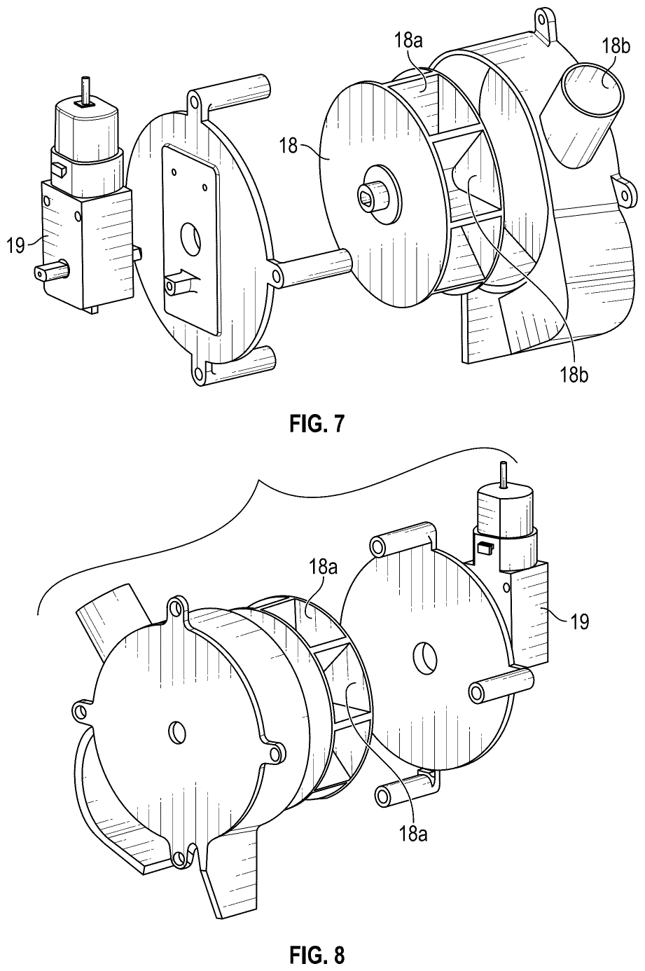

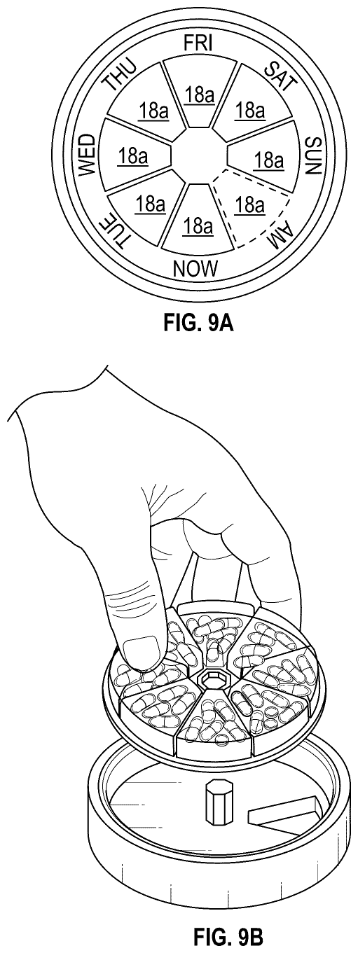

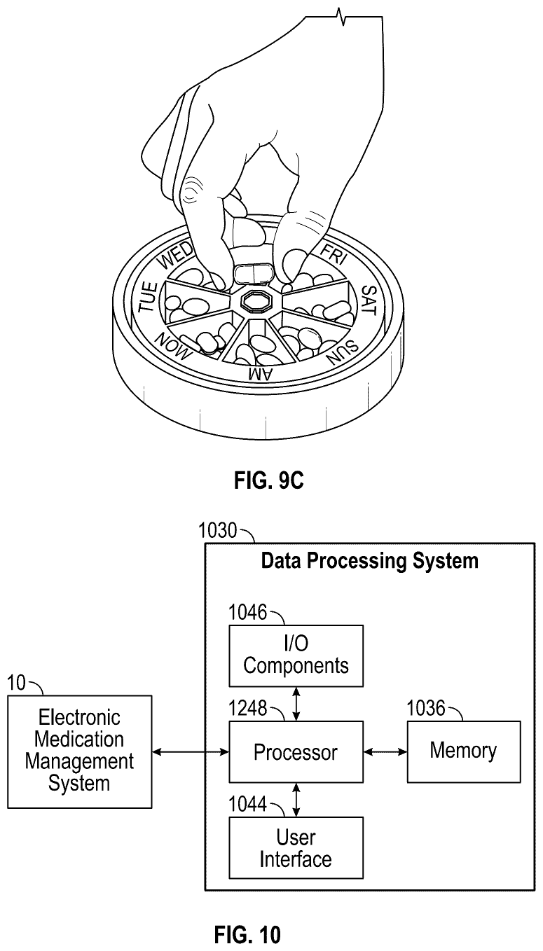

FIGS. 7 and 8 are diagrams illustrating the motor 19 and the paddle wheel 18 in accordance with some embodiments of the present inventive concept. As illustrated, the paddle wheel 18 is divided into multiple compartments 18a. As illustrated in FIG. 9A, these compartments 18a may correspond to the days of the week. However, embodiments are not limited thereto. For example, the compartments may correspond to various times of the day and more than one wheel 18 may be required to complete medication for a single day or week. As further illustrated in FIGS. 9B and 9C, the compartments 18a are loaded with medication based on the patient's needs and prescriptions and these loaded compartments 18a are positioned on the paddle wheel 18. In some embodiments, the compartments 18a may be preloaded by a medical professional, for example, a pharmacist. The medication may be preloaded in the wheel 18 and then the wheel may be inserted into the system 10 or the compartments may be loaded into the paddle wheel 18 via an aperture 18b. The aperture 18a illustrated in FIG. 7 has a conical shape that protrudes from the housing of the paddle wheel 18. The aperture 18a is in fluid communication with the compartments 18a on the paddle wheel 18. The motor 19, upon direction from, for example, a microprocessor or CPU, causes the paddle wheel to turn, allowing medication (e.g. pills shown in FIGS. 9B and 9C or powders) to fall out of a compartment 18a into the receptacle 14 or alternately into a container (FIG. 2) that is located in the receptacle 14. It will be understood that having a medical professional load the medicine into the wheel is likely to provide more accurate results, embodiments are not limited thereto. For example, a patient or a patient caretaker may also load the medication into the wheel.

In operation according to some embodiments, a user loads medication into the system 10 by opening the lid 12a and inserting medication into one or more of the compartments 18a of the paddle wheel 18. In some embodiments, each compartment 18a is loaded with a medication or medications to be taken by a patient at a predetermined time. For example, if a patient is supposed to take two (2) ibuprofen at 9 AM and then take Vitamin C at six (6) PM, the ibuprofen is loaded into one compartment 18a and the Vitamin C is loaded into a second compartment. At the designated time, the motor 19 that is operably connected to, for example, a processor, causes the paddle wheel 18 to turn to allow the medication in each designated compartment to be dispensed or released from the compartment 18a into the receptacle 14 having an optional container thereon, which engages the weight sensor 15. In some embodiments, the system 10 may include an internal clock and may not require communication with the processor to dispense medication. Data from the weight sensor 15 is processed to determine if the medication was dispensed into the receptacle 14. In some embodiments, the system (software enabled CPU) can, based upon weight, determine how much of a particular medication was dispensed and cross-reference that data with instructions regarding what medications are to be dispensed at particular times.

In some embodiments, the processor uses data received from the weight sensor 15 to confirm that the medication was dispensed as well as the removal of the medication from the receptacle 14. Further embodiments of the system 10 detect whether a container has been removed from and/or replaced in the receptacle 14 prior to additional medication or other substances being dispensed by the system 10. If the receptacle 14 is not emptied within a predetermined period of time, the system (processor), not detecting a change in weight, can be programmed initiate an alert, for example, on the readout 16, and/or to retransmit a signal to an external device via a transmitter. In some embodiments, an audible alert may be sounded if the medication is not removed within the predetermined period of time. The alter may also be visual or tactile or any combination thereof.

Referring now to FIG. 10, an example of a data processing system 1030 suitable for use with any of the examples described above will be discussed. Although the example data processing system 1030 is shown as in communication with an electronic medication management system 10 in accordance with embodiments of the present inventive concept, the data processing system 1030 may also be part of any other component of the system without departing from the scope of the present inventive concept. In some examples, the data processing system 1030 can be any suitable computing device for performing operations according to the embodiments discussed herein described herein.

As illustrated, the data processing system 1030 includes a processor 1048 communicatively coupled to I/O components 1046, a user interface 1044 and a memory 1036. The processor 1048 can include one or more commercially available processors, embedded processors, secure processors, microprocessors, dual microprocessors, multi-core processors, other multi-processor architectures, another suitable processing device, or any combination of these. The memory 1036, which can be any suitable tangible (and non-transitory) computer-readable medium such as random access memory (RAM), read-only memory (ROM), erasable and electronically programmable read-only memory (EEPROMs), or the like, embodies program components that configure operation of the data processing system 1030.

I/O components 1046 may be used to facilitate wired or wireless connections to devices such as one or more displays, game controllers, keyboards, mice, joysticks, cameras, buttons, speakers, microphones and/or other hardware used to input or output data. Memory 1036 represents nonvolatile storage such as magnetic, optical, or other storage media included in the data processing system and/or coupled to processor 1048.

The user interface 1044 may include, for example, a keyboard, keypad, touchpad, voice activation circuit, display or the like and the processor 1048 may execute program code or instructions stored in memory 1036.

It should be appreciated that data processing system 1030 may also include additional processors, additional storage, and a computer-readable medium (not shown). The processor(s) 1048 may execute additional computer-executable program instructions stored in memory 1036. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

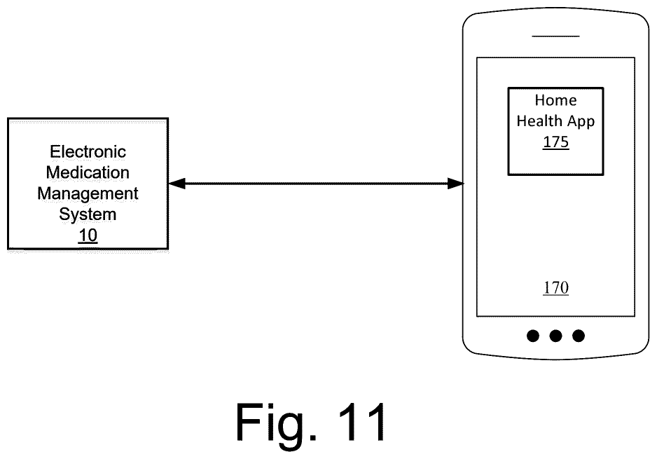

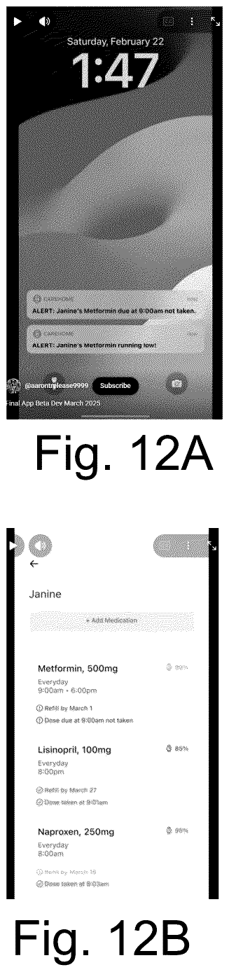

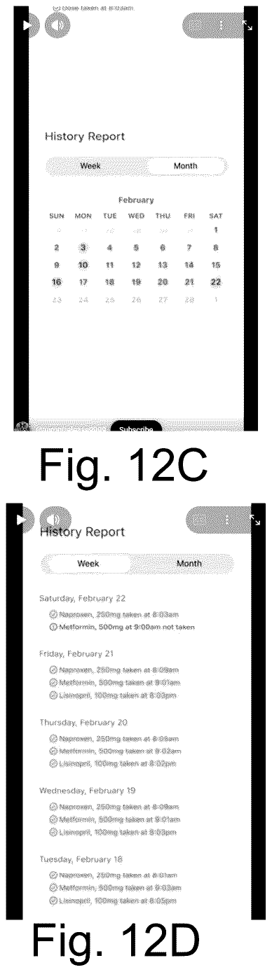

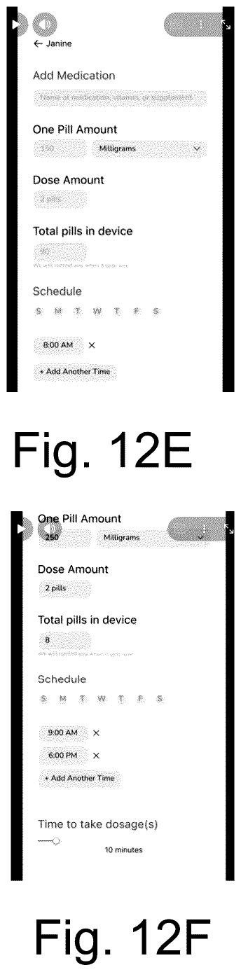

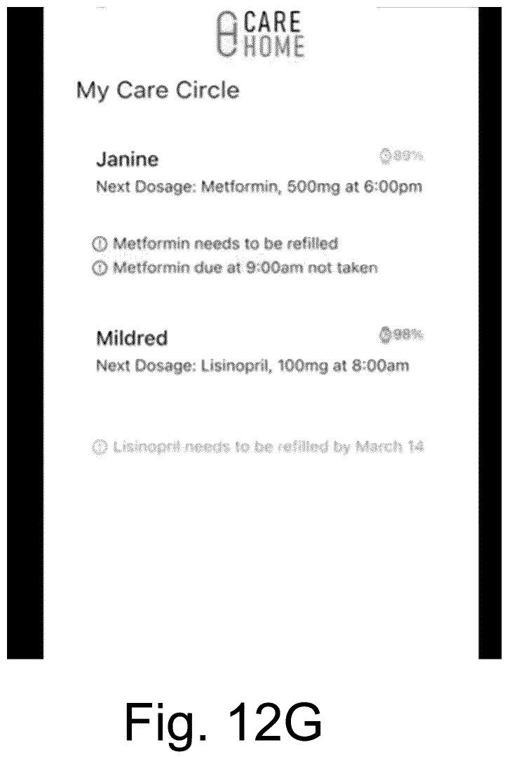

Referring now to FIG. 11, a system in communication with a mobile app in accordance with some embodiments of the present inventive concept will be discussed. As illustrated in FIG. 11, in some embodiments of the present inventive concept the system 10 may communicate with a mobile app 175 running on a portable device 175. Although the device 175 is depicted as a cell phone, the device can be any device capable of running the mobile app without departing from the scope of the present inventive concept. Thus, the mobile app 175 communicates with the system 10 to provide information related to the medication being dispensed from the system. For example, the mobile app 175 may, for example, remotely schedule times the system should dispense medications, receive missed-dose information via, for example, push notifications, store and update basic history reports (by day/week/month etc.); notify the caregiver of low doses; walk the caregiver through loading the medications and confirming each has been loaded with the appropriate amount and the like. These functions are provided as examples only and it will be understood that the mobile app 175 may have many other functionalities itemized herein. Example screen shots of a mobile app 175 in accordance with embodiments discussed here are provided in FIGS. 12A through 12G to illustrate example functionality thereof.

As discussed above, some embodiments of the present inventive concept track whether the medication that is dispensed is actually removed and therefore presumably taken, if the weight of the medication dispensed does not match the expected weight and the like. If an issue (intake issue) is detected, for example, if the receptacle is not picked up/placed back in a predetermined timeframe, the system 10 may automatically shut down and stop dispensing medication until the issue is rectified. As discussed above, the system may provide an alert to indicate a problem has occurred. In embodiments including the mobile app 175, this alert may be sent to the mobile app 175. The user/caregiver may confirm receipt of the alert on the mobile app 175 and confirm that issue has been attended to. Upon that confirmation, the system 10 may resume operation as normal.

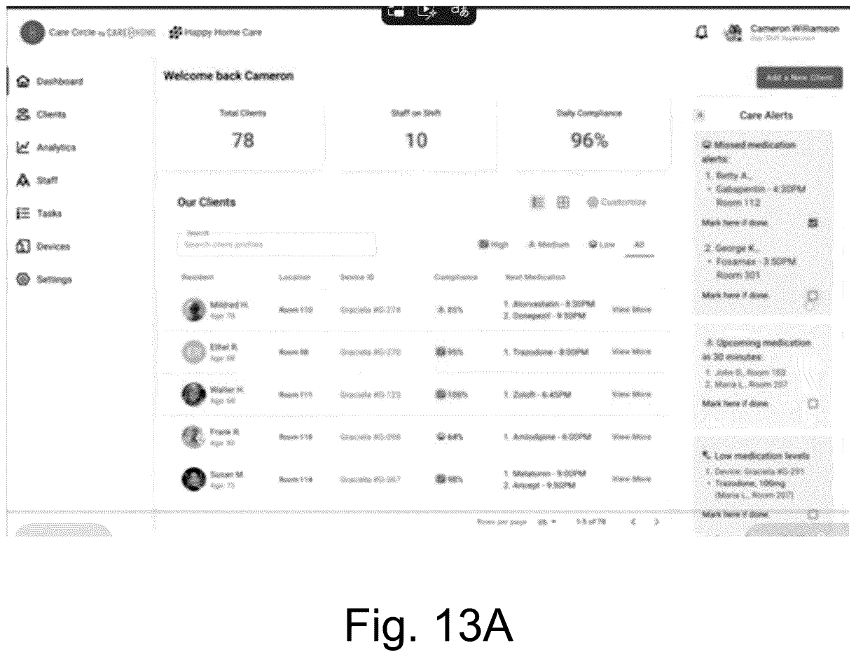

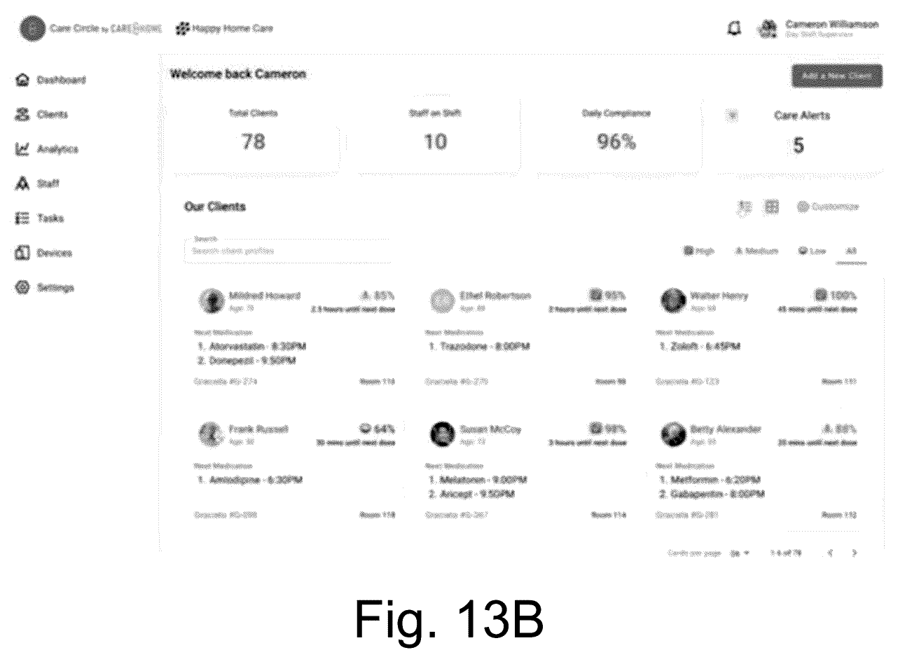

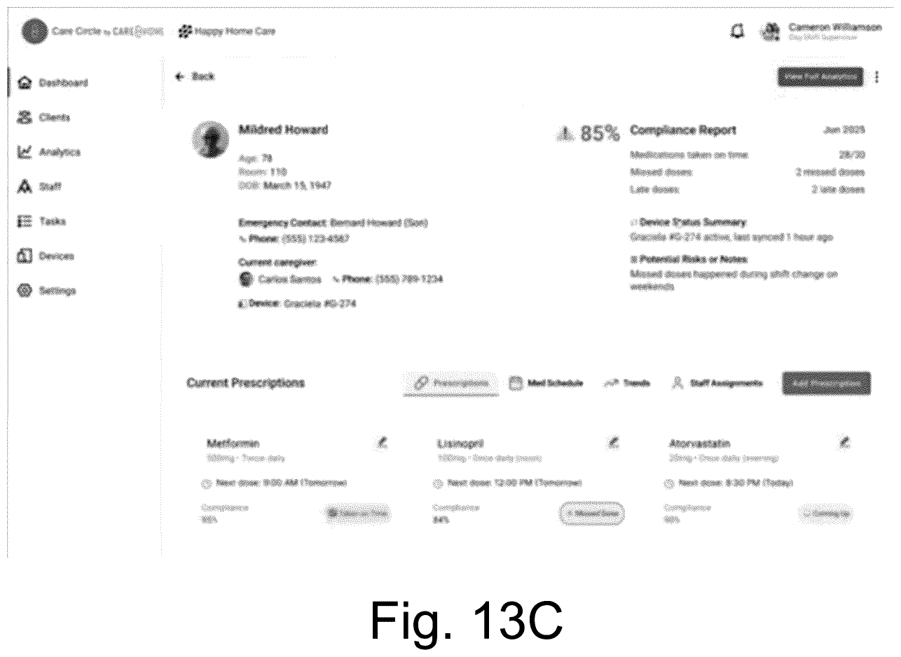

Furthermore, some embodiments of the present inventive concept provide a dashboard for use by, for example, caregivers. All data associated with a patient or multiple patients can be viewed through the dashboard. Thus, all compliance data for each system associated with different patients may be consolidates in one user friendly dashboard. FIGS. 13A through 13C provide example screenshots of a dashboard in accordance with some embodiments discussed herein. It will be understood that the screenshots in FIGS. 13A through 13C are provided as examples only and embodiments of the present inventive concept are not limited thereto.

As briefly discussed above, some embodiments of the present inventive concept provide a device and method of dispensing medication that bridges the gap between modern smart technology and antiquated forms of medication management. The device dispenses both solids and liquids. The device does not generally require the patient or medical personnel to interact with the device after the device is loaded.

The device includes a locked compartment that stores medication and/or other related substances. This system includes a pill wheel into which medication loaded from the upper compartment for dispensation. The device can also dispense fluid and powders.

Based on preprogrammed input, the device dispenses medication at a predetermined time and in a predetermined amount. The device includes a weight sensor that is operably connected to a processor that includes software necessary to operate the machine. After the device has dispensed medication, if the medication is not removed from the weight sensor within a specified time, then the system produces an alert. In addition, the system can produce an alert if the medication is removed, but the container is not placed back on the sensor within a specified time. Some embodiments of the device include a screen or readout that displays information such as an alert or a timer that indicate show long the medication has been present on the weight sensor. Other embodiments of the device can alert a caregiver or emergency contact by sending a message to an external device such as a cell phone.

Still further embodiments can detect whether the container is replaced within a certain time frame. Still other embodiments can, based upon the weight of the container, determine if the container was replaced with or without the medication that was to be consumed providing further feedback to a patient or medical provider.

In some embodiments, the system can dispense a liquid in response to the sensor detecting that the medication was removed from the weight sensor. This function can be used to provide the patient with water or other fluid that they can use to take with solid medication. The software that controls the device can be programmed to “look for” the cup with medication to be removed from the weight sensor and to be replaced prior to fluid dispensed.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random-access memory (SRAM), dynamic random-access memory (DRAM), or magnetic random-access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction. It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A medication management and dispensing system, the system comprising:
a housing;
a medication dispensing mechanism disposed within the housing, the medication dispensing mechanism including a plurality of compartments therein, each of the plurality of compartments configured to hold a predetermined dose of medication;
a motor in the housing and operably coupled to the medication dispensing mechanism that is configured to engage the medication dispensing mechanism at a predetermined time and cause the medication dispensing mechanism to release the dose of medication;
a receptacle disposed in the housing that receives the dispensed medication released by the medication dispensing mechanism; and
a weight sensor operably associated with the receptacle that detects a weight of the dose of medication when the dose of medication is released into the receptacle causing a user to be alerted of presence of the dose of medication in the receptacle.

2. The system of claim 1, further comprising a timer associated with the system, wherein the motor operates responsive to the timer.

3. The system of claim 1, wherein the medication dispensing mechanism is a paddle wheel having compartments therein.

4. The system of claim 3, further comprising a processor in communication with the motor and weight sensor that:
controls rotation of the paddle wheel according to a predetermined medication schedule; and
generates an alert when the weight sensor indicates the dose of medication is in the receptacle.

5. The system of claim 4, wherein the weight sensor detects whether a container placed on the receptacle contains consumed or unconsumed medication based on weight change patterns.

6. The system of claim 5, wherein the processor disables further medication dispensing until a previous dose has been removed, acknowledged, or cleared by a caregiver.

7. The system of claim 4, wherein the alert is one or more of an audible alert, a tactile alert and a visual alert.

8. The system of claim 4, wherein the processor further generates an alert when the dose of medication has not been removed from the receptacle within a predetermined time and when an actual weight of the dose of medication is less than an expected weight of the dose of the medication.

9. The system of claim 8, wherein the processor determines whether a container has been returned to the receptacle before dispensing additional medication.

10. The system of claim 3, wherein the paddle wheel is removable for external filling or replacement with pre-filled compartments.

11. The system of claim 1, wherein the housing includes a locking mechanism to restrict access to medication once the medication is loaded into the system.

12. The system of claim 1, further comprising a display on the housing, wherein the display communicates alerts, dosage information, timer information, and/or compliance feedback.

13. The system of claim 1, further comprising a reservoir in the housing, wherein the reservoir dispenses liquid into the receptacle.

14. The system of claim 13, wherein the liquid is one of liquid medication and liquid for aiding a patient in swallowing the dose of medication.

15. The system of claim 1, wherein the plurality of compartments correspond to days of a week and/or scheduled medication times.

16. The system of claim 1, further comprising a communication interface configured to transmit compliance data to an external device.

17. A method for dispensing medication, the method comprising:
loading a plurality of medication doses into respective compartments of a paddle wheel;
rotating the paddle wheel via a motor to position a medication-filled compartment over a receptacle at a scheduled dispensing time;
dispensing the medication into the receptacle;
detecting, using a weight sensor, an amount of dispensed medication in the receptacle;
comparing the detected amount with an expected medication dose; and
generating an alert when the detected amount differs from the expected amount or the medication remains on the receptacle beyond a predetermined time.

18. The method of claim 17, further comprising dispensing liquid to the receptacle in response to removal of the medication.

19. The method of claim 17, further comprising storing medication-compliance history including dispense times, removal times, and dosage verification data.

20. The method of claim 17, further comprising initiating transmission of an alert to an external caregiver device when medication was dispensed but not removed.
